(19) United States
(12) Patent Application Publication
(10) Pub. No.: US 2009/0055307 A1
(43) Pub. Date: Feb. 26, 2009

(54) Priority bid processor and protocol therefore

(76) Inventors: Viren Choudary, (US); Rahul Gedupudi, Hyderabad (IN)

Correspondence Address: CLIFFORD H. KRAFT, 320 ROBIN HILL DR., NAPERVILLE, IL, 60540, US

(21) Appl. No.: 12/221,228

(22) Filed: Jul. 31, 2008

(30) Foreign Application Priority Data
Aug. 20, 2007 (IN) 1848/CHE/2007

(51) Int. Cl. G06Q 40/00

(52) U.S. Cl. 705/37

(57) ABSTRACT

A financial transaction system, such as an automobile bidding system is disclosed. The financial transaction system comprises a demand placement module, a supply providing module, and an algorithm linking the demand placement module to the supply providing module. The priority based processor, which is configured to correlate a plurality of demand priorities to a plurality of supply priorities such that a maximum of one match is provided between the demand priorities and the supply priorities. A priority based correlation algorithm, a priority based algorithmic process and an automobile bidding system are also disclosed.

### PRIORITY BID PROCESSOR AND PROTOCOL THEREFORE

This application is related to and claims priority from Indian Application number 1848/CHE/2007 filed Aug. 20, 2007.

### BACKGROUND

1. Field of Invention

The present invention relates generally to an automated secured system for a financial transaction that is sensitive to buyer and seller priorities in an auction proceeding and more particularly to an automated secured system which allows trading of multiple commodities on the same trading platform and facilitates a maximum of one match between buyer priorities and seller priorities using an optional priority based processor configured to execute a priority based algorithmic process.

2. Background of Invention

In a typical auction, a prospective buyer bids on an item. In the event that he loses the bid, he generally has to find another item to bid on. Similarly, a seller is compelled to sell his commodity to the highest bidder irrespective of whether or not his price expectation is met.

It would be advantageous for a buyer to be able to bid on various items simultaneously at varying priorities with a reasonable expectation of success and for a seller to accept multiple winning bids at varying priorities to provide the seller the best possible price among several bids. It would be further advantageous for bidding priorities to be scaleable up to a predetermined upper bidding limit, and for the selling priorities to accept a sale price when the bid exceeds a predetermined minimum reserve price. Finally, it would be advantageous to provide a maximum of one match between overlapping demand priorities and supply priorities, and to provide for the aforementioned processes to be conducted in real-time such that changes and fluctuations in buying or selling priorities, or both, are continuously updated. Hence, there is a need for a priority based trading system and a trading protocol therefor.

### SUMMARY OF INVENTION

The present invention relates to a financial transaction system, such as a buying-selling platform and more particularly to a system and a method to efficiently transact multiple buying and multiple selling operations based on buyer and seller priorities.

The present invention meets these and other needs by providing a automated secured financial transaction system that is sensitive to buyer priorities and seller priorities, allows trading of multiple commodities on the same trading platform and facilitates a maximum of one match between buyer priorities and seller priorities using an algorithm. Frequently, the algorithm operates in real time.

Various features of the present invention are described herein including a network environment used with the present invention that includes a network, one or more servers, a plurality of communication appliances, or user locations, or participant systems, and one or more participant systems, optionally represented by wireless participant systems. Trading, transacting and executing orders can occur by the inter-operation of the components of network. For example, participant systems can be adapted and arranged to respond to orders generated by server. This response may occur as a result of preprogrammed instructions and typically occurs without intervention of an operator. It is an embodiment of the present invention that messages transmitted from servers to participant systems will not be visibly displayed on computer terminals.

Accordingly, one embodiment of the invention provides an automated secured financial transaction system. The automated secured financial transaction system includes: a network; at least one servers; a plurality of communication appliances, user locations, participant systems; at least one wireless participant systems; a demand placement module; a supply providing module; and an algorithm linking the demand placement module to the supply providing module. A priority based processor, which is configured for the execution of the said algorithm

A second embodiment of the invention provides a priority based correlation process that provides a maximum of one match between a set of demand priorities and a set of supply priorities. Frequently, the set of demand priorities is called a bid linear. Typically, a bid linear comprises a highest priority item, a lowest priority item and several other items with intermediate priorities.

A third embodiment of the invention provides a priority based algorithmic process for correlating several demand priorities to several supply priorities. The process comprises: providing multiple demand priorities; providing multiple supply priorities; electronically interfacing the demand priorities to the supply priorities using an algorithm; and updating changes in demand priorities and the supply priorities such that a maximum of one match is achieved upon correlating the demand priorities to the supply priorities.

A fourth embodiment of the invention provides an automobile bidding system. The automobile bidding system comprises: a bid placement module; a bid acceptance module; and a priority based bid processor. The priority based bid processor correlates the buyer priorities to the seller priorities to provide a maximum of one match between the aforementioned priorities.

These and other aspects, advantages, and salient features of the present invention will become apparent from the following detailed description, the accompanying drawings, and the appended claims.

### DESCRIPTION OF DRAWINGS

Referring now to the figures:

FIG. 1 is a schematic representation of a first embodiment of a financial transaction system of the present invention;

FIG. 2 is a schematic representation of second embodiment of a financial transaction system of the present invention;

FIG. 3 is a schematic representation of a third embodiment of a financial transaction system of the present invention;

FIG. 4 is a schematic representation of a fourth embodiment of a financial transaction system of the present invention;

FIG. 5 is a schematic representation of a fifth embodiment of a financial transaction system of the present invention;

FIG. 6 is a schematic representation of a sixth embodiment of a financial transaction system of the present invention;

FIG. 7 is a schematic representation of a seventh embodiment of a financial transaction system of the present invention;

FIG. 8 is a schematic representation of an eighth embodiment of a financial transaction system of the present invention;

FIG. 9 is a schematic representation of a ninth embodiment of a financial transaction system of the present invention;

FIG. 10 is a schematic representation of a tenth embodiment of a financial transaction system of the present invention;

FIG. 11 is a schematic representation of an eleventh embodiment of a financial transaction system of the present invention;

FIG. 12 is a schematic representation of a twelfth embodiment of a financial transaction system of the present invention;

FIG. 13 is a schematic representation of a thirteenth embodiment of a financial transaction system of the present invention;

FIG. 14 is a schematic representation of one embodiment of a priority based correlation process of the present invention;

FIG. 15 is a schematic representation of one embodiment of a priority based algorithmic process of the present invention; and

FIG. 16 is a schematic representation of one embodiment of an automobile bidding system of the present invention;

Several drawings and illustrations have been provided to aid in understanding the present invention. The scope of the present invention is not limited to what is shown in the figures.

### DESCRIPTION OF THE INVENTION

The present invention relates to a financial transaction system, such as a buying-selling platform and more particularly to a system and a method to efficiently transact multiple buying and multiple selling operations based on buyer and seller priorities.

Referring to a typical buyer and seller engagement in a conventional auction, it is seen that a customer typically places a bid on an item of choice. If the customer loses the bid, he (or she; referred to hereinafter in the masculine for illustrative purposes only) has to find another item to bid upon. Conversely, the seller is also compelled to sell his commodity to the highest bidder, irrespective of whether or not his price expectation is met.

The network is, for example, any combination of linked computers, or processing devices, adapted to access, transfer and/or process data. The network may be private Internet Protocol (IP) networks, as well as public IP networks, such as the Internet that can utilize World Wide Web (www) browsing functionality, or a combination of private networks and public networks.

The Servers are operatively connected to network, via bi-directional communication channel, or interconnector, or other wire or wireless transmission medium. The interconnector may be used to feed, or provide, order data to server. The elements so connected or coupled are adapted to transmit and/or receive data, or otherwise communicate. The transmission, reception or communication is between the particular elements, and may or may not include other intermediary elements. This connection/coupling may or may not involve additional transmission media, or components, and may be within a single module or device or between one or more remote modules or devices. The server is adapted to access data, transmit data to, and receive data from, participant systems, via the network.

The Participant systems are typically processes that reside on computers. They may be capable of processing and storing data themselves or merely capable of accessing processed and stored data from another location (i.e., both thin and fat terminals). These participant systems are operatively connected to network, via bi-directional communication channels respectively or other wire or wireless transmission medium, as described herein.

The servers, which are adapted to access, store and process data related to the present invention, is operatively connected to the network, via interconnector. The servers are adapted to receive order data from participant systems and store or process the data such that transactions can be executed. The processing of the data includes process of matching bidder priorities to seller priorities is done by a Priority-Based Bid Processor (referred to hereinafter as “PRIBPRO”). PRIBPRO is a multi-priority based bid processing engine and its working is explained in subsequent sections of this specification. The servers are also adapted to provide data related to proposed transactions to other participant systems. The servers are also adapted to generate settlement report as well as report quotes and trades to a information processor as well as store and provide audit information to an appropriate authority or regulatory agency. The memory also includes algorithms, or program code, which are typically stored on a computer-readable memory or medium and executed by a processor. These algorithms are discussed in more detail herein. The memory also stores matching engine, module or facility, which is software, program code or algorithm, adapted to match bids and asks for financial instruments. The matching engine facilitates transactions by determining transactions that that may be executed and when the transaction may be executed.

In one embodiment of the present invention, each bid allows for an exemplary, three priorities. The set of three bidding priorities is called a bid linear. In other words, when a buyer places a bid, he has the option to bid on three unique items under the same bid linear. Each item will have a different priority, and the bidder is mandated to pay only for the winning item, which is determined by the bid-processing algorithm (60) of the current invention.

The present invention allows a bidder to bid on multiple items with differing priorities at the same time, but only have one winning item from the bid linear. The algorithm hence substantially reduces the time spent by the bidder in acquiring an item. The algorithm in the aforementioned form becomes somewhat biased towards the bidder. Hence, another embodiment of the present invention compensates for the bidder tilt by providing three (or more) priorities to the seller as well. In other words, a seller may choose up to three potential winning bidders with different priorities. The seller will be mandated to sell the item to either one of the three (or more) bidders.

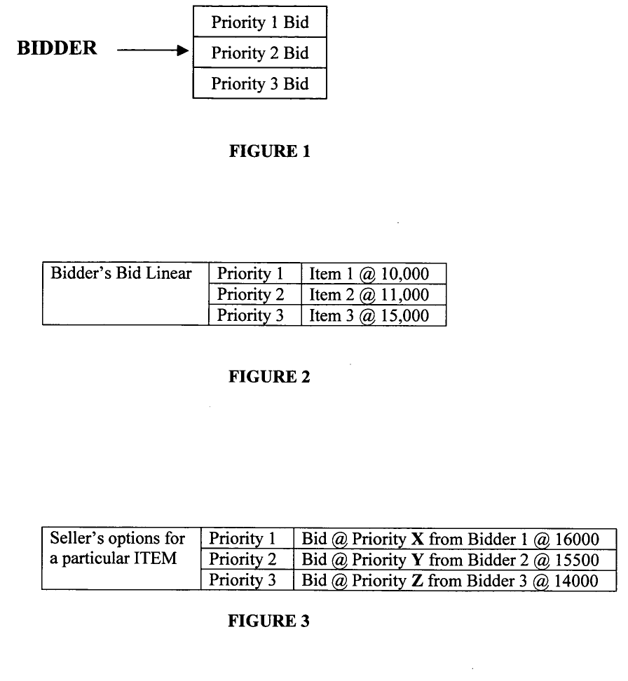

A bid linear of the present invention generally refers to multiple bids of differing priorities. In one embodiment of the present invention, the bid linear comprises three bidding priorities. The size of the bid linear can be extended to any natural number and its size is generally limited only by practical constraints than by limitations in the capabilities of the algorithm of the present invention. A schematic representation of one embodiment of a bid linear of the current invention is shown in FIG. 1 As opposed to a an unrelated sequence of individual bids, a bidder of the current invention uses a bid linear that provides the ability to bid on a large number of items with varying priorities. All of the priorities are tied together in the bid linear. Even if the bidder is accepted as the preferred bidder by the multiple sellers from the bid linear, he is mandated to pay only for the item that is declared as the winning item by PRIBPRO, the bid processing algorithm of the current invention.

Turning to the representation illustrated in FIG. 2 of the current invention, if the bidder's priority 1 Bid on Item 1 at a currency amount of 10,000 units is not accepted by the seller, but is selected by sellers for both Item 2 at 11,000 units and Item 3 at 15,000 units, the bid processing algorithm of the current invention (PRIBPRO) provides that the bidder may win only one item from either Item 2 or Item 3. In the aforementioned example, the bid amount increasing at each priority is only an exemplary illustration, the bidder can bid at any amount at any priority. Also, the bidder is not required to enter bids at every priority.

A seller of the current invention, may receive for every item, various bids at various priorities from the bidders. Unlike the traditional model where the seller is mandated to accept the highest bid for the item, the financial transaction system of the present invention allows the seller to select up to three (or more) top bids at different priorities. Presenting the non-top bidders allows the financial transaction system to be manipulated where a bidder can always place a highest bid on his own item so as to artificially inflate the price.

The rationale is that the seller may choose the best bid-price as his first priority. However, this bid may be the bidder's last priority in his bid linear, which would mean that the seller is taking a chance that the bidder will not win his (or her; referred to hereinafter in the masculine for illustrative purposes only) bids with higher priorities. The seller selects his priorities such that if the seller does not get matched to the bidder he has chosen as his first priority, he will consider the offer from the bidder he has chosen as their second priority and so on. A non-limiting example of the current embodiment of the present invention is presented in FIG. 3.

The following example is included to illustrate the various features and advantages of the present invention, and is not intended to limit the invention.

### EXAMPLE 1

### An Automobile Bidding System

The protocol of the financial transaction system of the current invention is typically, computer based. Data from the bid linears is entered into the system by the bidders, sellers, or system operators who gather the information from the bidders or sellers. Sellers bring their cars to the automobile bidding system of the current invention for auction and provide the necessary authorization to permit placing the cars on auction. At this time all information about the seller as well as the automobile is gathered and entered into the financial transaction system records. Once the cars are present at the bidding system, the bidding process begins. The bidding process is typically divided into three phases: Bid placement, bid acceptance and operation of the PRIBPRO engine.

Bid placement involves the buyers (or bidders) to inspect the vehicles on the auction site and thereafter to place bids. This phase lasts for a pre-defined time interval (up to about 5:00 pm each day). At the end of this interval, all bidding is closed and is only reopened after the PRIBPRO algorithm finishes execution and the winners are announced. By design, bidding reopens only the next day. However, bid reopening can also be scheduled to any other time or event.

Typical bidding processes are described hereunder. When a bidder places a bid, he is specifying the starting amount for the bid and the maximum amount that he is willing to bid on a particular item. He also specifies his terms of payment, such as Pay in Full Now, or Pay Partially now, and remaining in 1 week, and so on. The system optionally, works on a concept of Auto-Bid, where if a second bidder places a bid that is of higher amount than the first bid, the system automatically bids for the first bidder and increases his original bid to an amount that is a fixed amount (e.g. 1000 currency units) higher than the second bidder's amount. Auto-bidding may be active for all bidders and operates only until the maximum amount specified by the bidder is reached. During the auto-bid, the priority of the user's bid will be maintained. For instance, if the user enters a bid for an item for 50,000 currency units at priority 2, up to a maximum amount of 80,000 currency units, the priority stays at 2, even though the amount is being updated automatically by the system.

While bidding, bidders will place bids at varying priorities on items that they are interested in bidding. Some basic bidding rules apply. These include, but are not limited to those mentioned hereunder:

(i) Each new bid on an item may or may not be unique. For instance, if there is an existing bid at priority 1 for a car priced at 100,000 currency units, another bid at the same amount and the same priority will also be accepted by the system. However, the bidder who placed his bid first is deemed the higher bidder. This is relevant because, the system provides for auto-bidding, and in a scenario where two bidders use the same maximum bid amount, it is possible that they may end up with the same bid amount and priority.

(ii) A bidder always has to fill in the higher priority slots in his bid linear before he may place bids at lower priorities. As an illustrative example, this provision implies that the bidder cannot place a Priority 3 bid unless both Priority 1 and Priority 2 bids are placed.

(iii) A bidder can revise his bid amounts upward or downward before the end of the bid placement period. This provision is facilitated because the bids are finalized only at the end of the bid placement period. However, highest amount bids may only be revised upwards. This provision is introduced to prevent bidders from placing bids at a high value that may discourage other potential bidders from participating in the auction, only for the highest bidder to revise his bid to a lower numerical value just before the closing of bid placement.

(iv) A bid once placed may not be removed. Particular and exceptional cases may be managed manually by the handling staff.

(v) At the end of each day, all unsold items are restocked for bidding on a clean slate. This feature helps in accelerating the sale because sellers do not have an option to sit-on or to delay decision on a bid until the item has reached its maximum allocated time (of seven days, in an exemplary situation) on the auction floor.

During the bid acceptance phase bidders are presented with information that may help make a decision on their bids. This information provided to them by the bidding system is typically of the hereinafter mentioned nature:

(i) Items—A list of all vehicles that are available for bidding is displayed to the a prospective bidder. For each vehicle, the year of manufacture, the make, model, color of the automobile, along with other elements (such as accident history, major and minor repairs performed, number of prior owners and similar details relevant to the automobile) are made available.

(ii) Inspection Report—The automobile bidding system and the operations staff may with the consent of the seller, typically perform a customary inspection of each vehicle. The information is presented to the bidder to enable placement of well informed and well assessed bids.

(iii) For each vehicle, the top running bid in each priority is displayed to the bidder. The information allows the bidder to better predict his chances of winning the bid. It also maximizes the potential for the sellers as the possibility of finding the best price substantially increases.

(iv) The bidder is also shown the historical highest bid amounts for an item that was not accepted by the seller or bid statements that were accepted by the seller but not finalized by the PRIBPRO algorithm of the current invention.

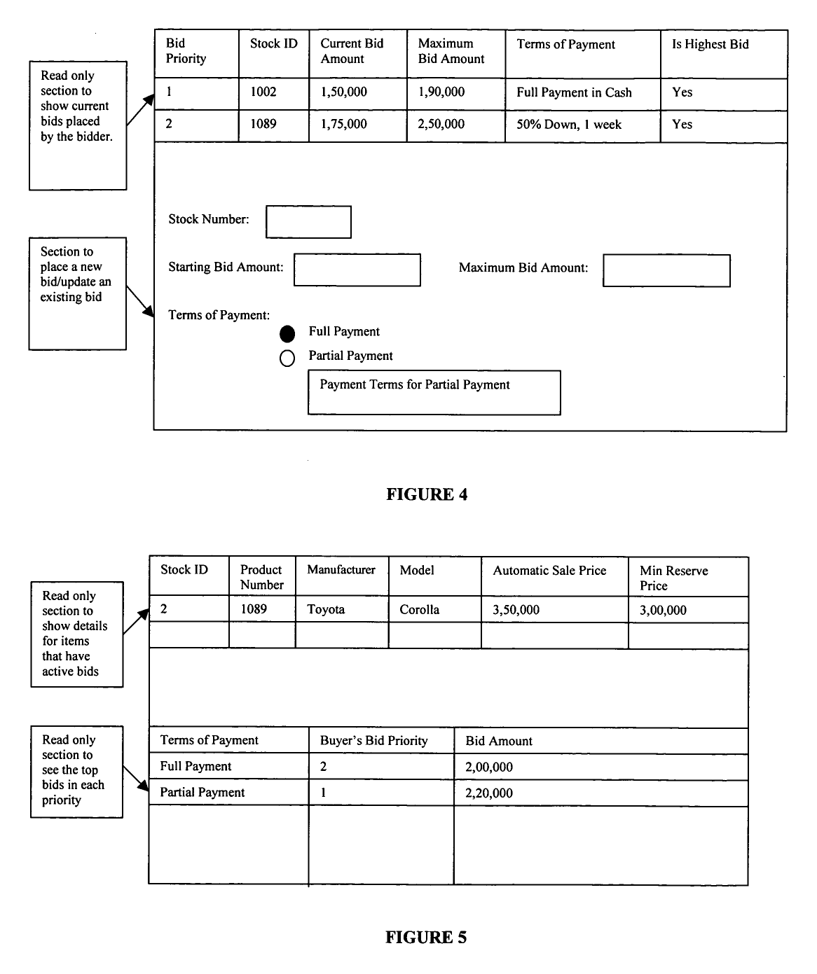

An exemplary bidding interface provided by one embodiment of the current invention is presented in FIG. 4. Turning to FIG. 4, one embodiment of the present invention provides a display for the screen elements to be shown to the bidder. The screen first shows a table containing the various bids that are placed by the bidder under a selected bid linear. Each row in the table represents a bid, and information such as priority of the bid, the item's unique ID, current bid amount, maximum bid amount (auto bid), terms of payment, and an indicator indicating if this bid is the highest bid on that item is shown. A provision exists to move a lower priority bid to a higher priority and vice versa via the “Move Up” and “Move Down” buttons. The screen also shows the fields that are to be entered by the user to create a new bid.

The aforementioned fields include, but are not restricted to the following, and a combination thereof:

(i) the item's unique identifier (stock number for the vehicle)

(ii) the minimum (starting price) and maximum bid amount

(iii) terms of the payment such as full payment, or a down payment with the remaining amount payable in a certain number of days, if the bidder wins the item.

The second phase, i. e. Bid Acceptance, is initiated immediately after bid placement is completed. Bid acceptance involves the sellers to select and optionally, accept bids that they have received on their items. The seller may either accept the bid or choose to disregard it. The seller's choosing of the bid only indicates his willingness to sell the item to the bidder at that price if the bid processing engine of the current invention (PRIBPRO), determines that there is a match in the seller and buyer preferences.

The seller is presented with the highest bids that he has received at each priority level. He may choose to accept the bid or ignore it if it does not meet their expected price. The seller may also choose up to a certain number of bids as their accepted ones (for illustrative purposes, the number of bids is three in this case). The number of bids can be extended to any natural number and its size is generally limited only by practical constraints than by limitations in the capabilities of the algorithm of the present invention. Each of the accepted bids however, has to be at a different priority.

During the bid acceptance phase sellers are presented with information that may help make a decision on the sale of their items. The information provided to the seller by the bidding system is typically of the hereinafter mentioned nature:

(i) Number of bids—This statistic indicates to the seller the interest among bidders for the seller's item or items.

(ii) The highest bid Amount received at each priority level for a specific bid placement interval.

(iii) Terms of payment for each highest bid—The possible options, without limitation, are “Pay in Full Now” or “Pay Partial Amount Now and the balance amount in 1 Week”.

(iv) Bidder's information such as name and contact details.

An exemplary selling interface provided by one embodiment of the current invention is presented in FIG. 5. Turning to FIG. 5, one embodiment of the present invention provides a display for the screen elements to be shown to the seller to consider or accept winning bids:

(i) Under the Customer details section, the information related to the customer such as their name and other contact information is shown.

(ii) The section “Cars with active bids”, lists all items that the seller has placed on the auction site.

(iii) The final section shows all the bids that have been placed by different bidders on one particular item, and includes details such as the Amount, Priority, and the Terms of Payment.

The third phase, i. e. Operation of the priority based bid processor (PRIBPRO) engine is initiated after the bidders and sellers have chosen their priorities. Data is entered into the PRIBPRO engine. Upon operation, the engine matches the bidder priorities to seller priorities and algorithmically attempts to find a maximum of one match. PRIBPRO runs at specific intervals after the completion of bid acceptance phase, typically at the end of each day, and accumulates all the bids marked as accepted at different seller priority levels in the system till that time, PRIBPRO sorts this data set for subsequent correlation.

The PRIBPRO Algorithm works on the process of elimination. With each iteration, the algorithm eliminates a certain set of records, starts the processing with the remaining set, and at the end of each iteration, comes up with the matched (or correlated) results.

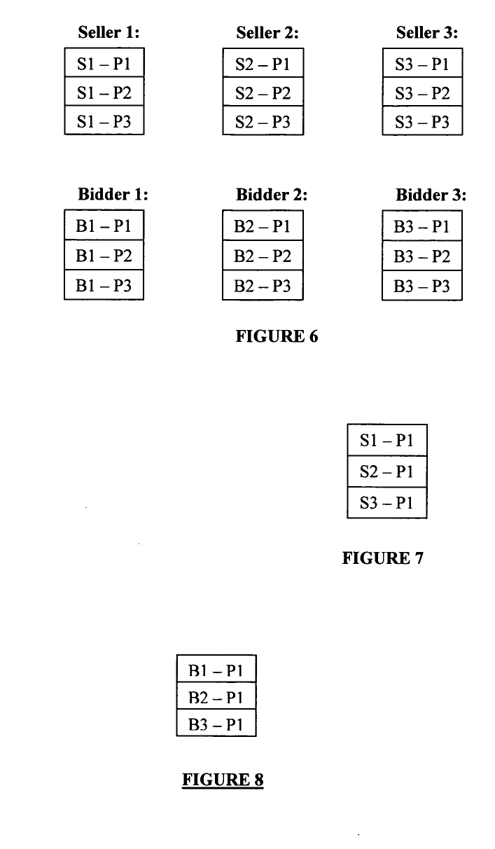

As an efficiency step, before starting the iterations, the algorithm eliminates all cars entries that have not been bid upon. Considering the following illustrative, non-limiting example, with three sellers and three bidders (the same scenario can be extended to several sellers and multiple bidders) each seller has three priorities, and each buyer has three priorities. For this illustration, it is provided that all sellers and all buyers have selected all their three priorities. However, it is not required for them to do so. The buyer and seller priorities are illustrated in FIG. 6. The algorithm protocol of the present invention operates in accordance with the exemplary process toll-gates indicated hereunder.

Steps:

1. Start with the sellers (S1, S2, and S3), and create a list of their first preferences (S1-P1, S2-P1, and S3-P1), as illustrated in one embodiment of the invention presented in FIG. 7.

2. Create a list of buyers and their first preferences (B1-P1, B2-P1, and B3-P1), as illustrated in one embodiment of the invention presented in FIG. 8.

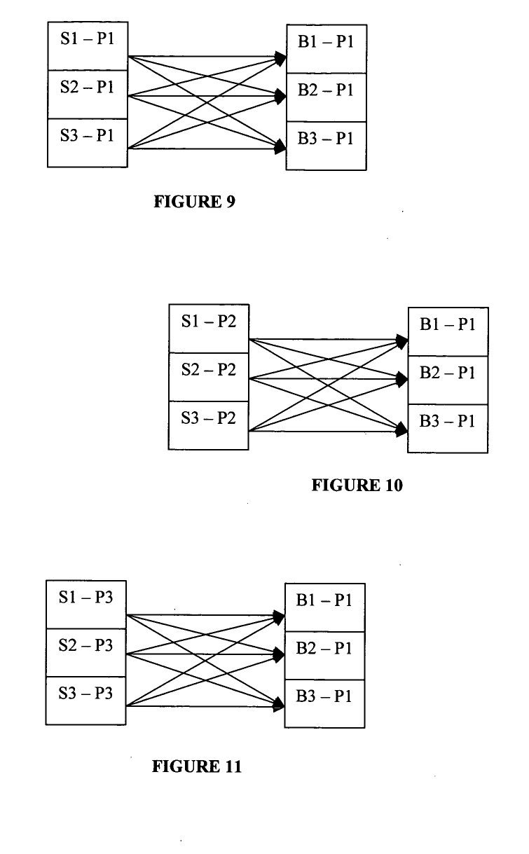

3. For each seller preference, determine if the seller's first preference is the same as a buyer's first preference, and if so, mark that bid as an accepted bid, as illustrated in one embodiment of the invention presented in FIG. 9. In this illustration, if S1-P1 is the same as B2-P1, then it is considered a match and B2 has a winning priority 1 bid. Since seller 1 has accepted this bid, their item's priority 2 selection and priority 3 selections are now invalid, and hence removed from the list. Similarly, bidder 2's second and third priority bids are also removed from the system.

4. Repeat the aforementioned step with the seller's second priorities. Typically, S1 and B2 priorities are removed from the system but they are indicated in the illustrative example shown in FIG. 10 for clarity and to demonstrate the working steps in the algorithm protocol. At the end of this step, the rows are eliminated.

5. Repeat the aforementioned step with the seller's third priorities. One embodiment of the protocol is illustrated in FIG. 11. At the end of this step, the rows are eliminated.

6. When all of the seller's preferences against the bidder's first priority have been exhausted, steps 3 through 5 are repeated with the bidder's second priority, followed by the bidder's third priority.

7. At the end of the algorithm run, all the matching bids are eliminated, allowing the winning bidders to proceed with the payment to the sellers.

The aforementioned algorithm process flow provides that sellers get the best possible price for their items, while buyers get their chosen merchandise at their price preference in the order of their priority.

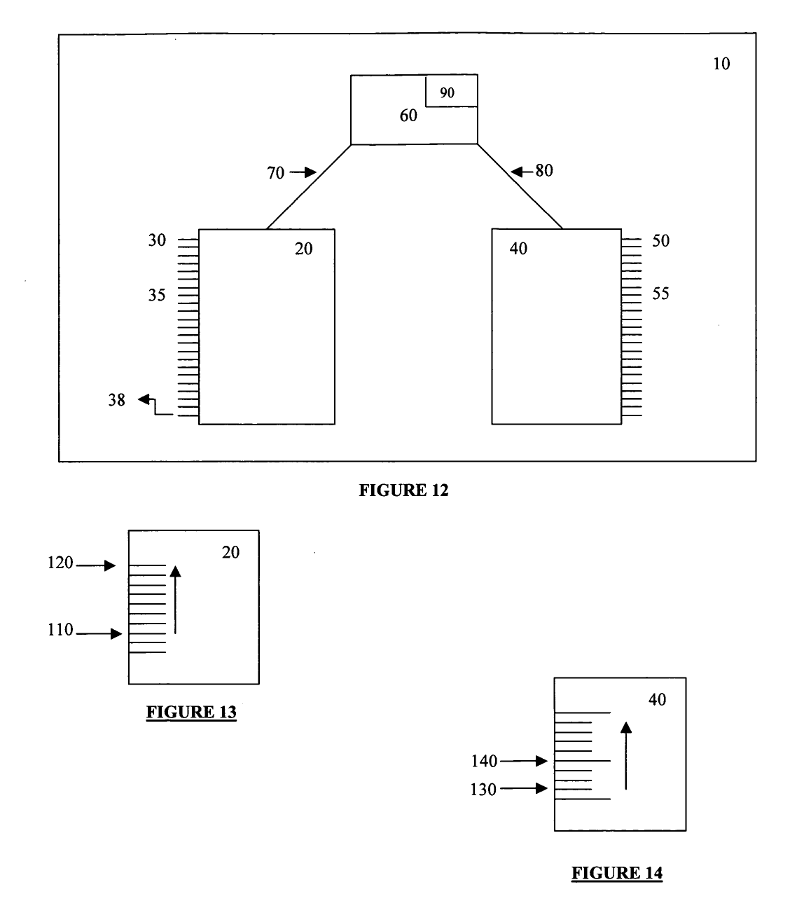

Referring to the drawings in general and to FIG. 12 in particular, it will be understood that the illustrations are for the purpose of describing a preferred embodiment of the invention and are not intended to limit the invention thereto. Turning to FIG. 12, a schematic representation of a financial transaction system 10 of the present invention is shown. Among the systems, devices, apparatuses and platforms that fall within the scope of the present invention are trading interfaces, real and virtual markets, brokering houses, auction houses and auction sites transaction forums. However, it will be appreciated by those skilled in the art that other transaction arrangements, provisions and devices will fall within the scope of the invention.

As schematically illustrated in FIG. 12, one embodiment of the financial transaction system (10) of the present invention comprises a demand placement module (20), a supply providing module (40), and an algorithm (60) linking the demand placement module (20) to the supply providing module (40). Algorithm (60) is a priority based processor (90) that correlates a plurality of demand priorities (35) to a plurality of supply priorities (55).

Generally, the plurality of demand priorities (30, 35) comprises a bid linear (38). Typically, the financial transaction system provides a plurality of supply priorities (50, 55).

In one embodiment of the present invention shown in FIG. 13, the demand placement module (20) is configured for automatically specifying the numerical value of a bid (110) up to a predetermined upper limit (120). In another embodiment of the present invention shown in FIG. 14, the supply providing module (40) is configured for automatically accepting a sale price (130) when it exceeds a predetermined minimum reserve price (140).

Returning to FIG. 12, the priority based processor (90) of the current invention provides a maximum of one match upon correlating the plurality of demand priorities (35) and the plurality of supply priorities (55). Frequently, the plurality of demand priorities (35) and the plurality of supply priorities (55) are correlated by priority based processor (90) in real-time.

A second embodiment of the present invention, provides a priority based correlation process (60) comprising a maximum of one match between a plurality of demand priorities (35) and a plurality of supply priorities (55). The priority based process (60) of the present invention is executed by at least one of a computer, a microprocessor, an embedded systems architecture, and a combination thereof. The plurality of demand priorities (35) generally comprises at least one of a financial transaction, a stimulus, a varied parameter, and a combination thereof. Accordingly, the plurality of supply priorities (55) comprises at least one of a financial sale, a response, a measured parameter, and a combination thereof.

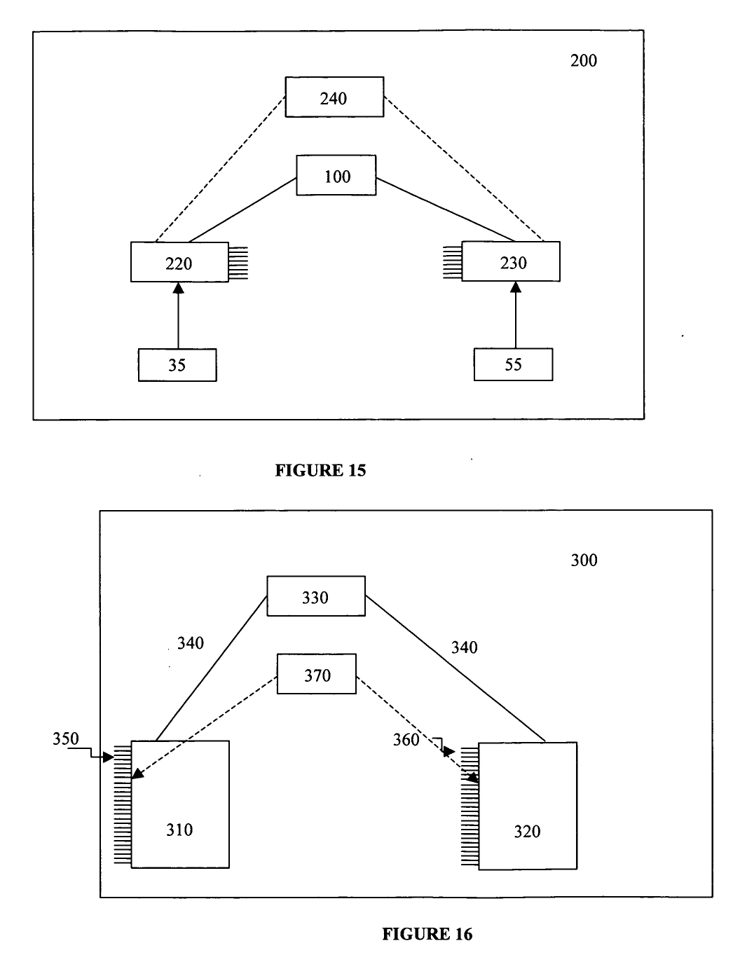

A third embodiment of the present invention, illustrated in FIG. 15, provides a priority based algorithmic process (200) for correlating (240) a plurality of demand priorities (35) to a plurality of supply priorities (55). The process comprises: providing a plurality of demand priorities (220), providing a plurality of supply priorities (230), electronically interfacing (240), the plurality of demand priorities (35) to the plurality of supply priorities (55) using an algorithm, and updating changes in at least one of the demand priorities (35) and the supply priorities (55) such that a maximum of one match (100) is achieved upon correlating the plurality of the demand priorities (35) to the plurality of the supply priorities (55).

A fourth embodiment of the present invention, illustrated in FIG. 16, provides an automobile bidding system (300) using: a bid placement module (310), a bid acceptance module (320), and a priority based bid processor (330), wherein the priority based bid processor (330) correlates (340) a plurality of buyer priorities (350) to a plurality of seller priorities (360) to provide a maximum of one match between buyer priorities and seller priorities (370).

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

### Element List

10 financial transaction system
20 demand placement module
30 demand
35 plurality of demand priorities
38 bid linear
40 supply providing module
50 supply
55 plurality of supply priorities
60 algorithm
70 link between algorithm and demand
80 link between algorithm and supply
90 priority based processor
100 maximum of one match
110 numerical value of a bid
120 predetermined upper limit
130 sale price
140 predetermined minimum reserve price.
200 Priority based algorithmic process
210 correlating step
220 providing a plurality of demand priorities
230 providing a plurality of supply priorities
240 electronically interfacing the demand priorities to the supply priorities
300 automobile bidding system
310 bid placement module
320 bid acceptance module
330 priority based bid processor
340 correlation step
350 plurality of buyer priorities
360 plurality of seller priorities
370 maximum of one match between buyer priorities and seller priorities

What is claimed is:

1. An automated secured financial transaction system comprising:
a network;
at least one server connected to said network;
a plurality of communication appliances at user locations, said communications appliances connected to said network;
at least one participant system;
a demand placement module;
a supply providing module; and
an computer program running on a priority based processor linking the demand placement module to the supply providing module.

2. The financial transaction system of claim 1, wherein the plurality of demand priorities comprises a bid linear.

3. The financial transaction system of claim 1, wherein the financial transaction system provides a plurality of supply priorities.

4. The financial transaction system of claim 1, wherein the priority based processor provides a maximum of one match upon correlating the plurality of demand priorities and the plurality of supply priorities.

5. The financial transaction system of claim 1, wherein the demand placement module is configured for automatically specifying the numerical value of a bid up to a predetermined upper limit.

6. The financial transaction system of claim 1, wherein the supply providing module is configured for automatically accepting a sale price when it exceeds a predetermined minimum reserve price.

7. The financial transaction system of claim 1, wherein the plurality of demand priorities and the plurality of supply priorities are correlated by a priority based processor in real-time.

8. The financial transaction system of claim 1 further comprising a priority based correlation process including the step of obtaining a maximum of one match between a plurality of demand priorities and a plurality of supply priorities.

9. The financial transaction system of claim 8, wherein the plurality of demand priorities is provided by a bid linear.

10. The financial transaction system of claim 8, wherein the priority based correlation process provides a plurality of supply priorities.

11. The financial transaction system of claim 8, wherein the priority based process is executed by at least one of a computer, a microprocessor, an embedded systems architecture, and a combination thereof.

12. The financial transaction system of claim 8, wherein the plurality of demand priorities comprises at least one of a financial bid, a stimulus, a varied parameter, and a combination thereof.

13. The financial transaction system of claim 8, wherein the plurality of supply priorities comprises at least one of a financial transaction, a response, a measured parameter, and a combination thereof.

14. A priority based process for correlating a plurality of demand priorities to a plurality of supply priorities, said process comprising the steps of:
a) providing a plurality of demand priorities;
b) providing a plurality of supply priorities;
c) interfacing electronically, the plurality of demand priorities to the plurality of supply priorities using an algorithm; and
d) updating changes in at least one of the demand priorities and the supply priorities such that a maximum of one match is achieved upon correlating the plurality of the demand priorities to the plurality of the supply priorities.

15. The priority based claim 14, wherein the bid linear of demand priorities is configured for automatically specifying the numerical value of a bid up to a predetermined upper limit.

16. The priority based process of claim 14, wherein the supply priorities are configured for automatically accepting a sale price when it exceeds a predetermined minimum reserve price.

17. The priority based process of claim 14, wherein the step of interfacing electronically, the plurality of demand priorities to the plurality of supply priorities using an algorithm comprises at least one of a computer, a microprocessor, an embedded systems architecture, and a combination thereof.

18. The priority based process of claim 14, wherein the plurality of demand priorities comprises at least one of a financial bid, a stimulus, a varied parameter, and a combination thereof.

19. The priority based process of claim 14, wherein the plurality of supply priorities comprises at least one of a financial sale, a response, a measured parameter, and a combination thereof.

20. An automated secured automobile bidding system comprising:
a network;
at least one server connected to said network;
a plurality of communication appliances at user locations on said network;
a plurality of wireless participant systems communicating with said network;
a bid placement module running on a priority based bid processor;
a bid acceptance module also running on said priority based bid processor; and
wherein the priority based bid processor is configured to correlate a plurality of buyer priorities to a plurality of seller priorities to provide a maximum of one match between buyer priorities and seller priorities.
